(19) United States
(12) Patent Application Publication
(10) Pub. No.: US 2005/0195136 A1
(43) Pub. Date: Sep. 8, 2005

(54) [COLOR CORRECTION CIRCUIT OF DISPLAY AND CORRECTION METHOD THEREOF]

(76) Inventor: Jian-Chin Liang, Changhua County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/709,589

(22) Filed: May 17, 2004

(30) Foreign Application Priority Data
Mar. 4, 2004 (TW) 93105654

(51) Int. Cl. H04N 1/00

(52) U.S. Cl. 345/72

(57) ABSTRACT

A color correction circuit of a display and a correction method thereof are provided. The color correction circuit comprises a video look-up circuit, N+M bit data driving circuit and N+M bit data gamma voltage generating circuit. The video look-up circuit modulates N bit video data into N+M bit video data. The N+M bit data gamma voltage generating circuit provides the voltage in every step to produce a suitable gamma correction curve for red, green and blue color in the display so that the brightness and darkness level of every color is optimized.

### CROSS REFERENCE TO RELATED APPLICATIONS

This application claims the priority benefit of Taiwan application serial no. 93105654, filed on Mar. 4, 2004.

### BACKGROUND OF INVENTION

1. Field of the Invention

The present invention relates to a color correction circuit. More particularly, the present invention relates to the color correction circuit of a display and correction method thereof for independently optimizing the operating voltage range of red, green and blue color in the display.

2. Description of the Related Art

Ever since the discovery of liquid crystal materials in Europe, researchers in the USA and Japan have continued to explore its physical properties and practical uses in real life applications so that new generations of flat panel liquid crystal display emerges from time to time. At present, various techniques for fabricating liquid crystal devices are used for manufacturing liquid crystal displays. Moreover, the size and scale of LCD production is increasing continuously. Yet, the voltage-transmittance relationship for the three colors, namely red, green and blue, are so different that each color preferably has a corresponding gamma correction curve. In other words, three sets of gamma correction curves and hence three sets of digital/analogue conversion circuits are preferably deployed inside the data driving circuit of the LCD. However, incorporating three sets of digital/analogue conversion circuits inside the data driving circuit not only increases the complexity of the integrated circuit significantly, but also increases overall production cost. Thus, most designs use a single gamma correction curve to service all three colors.

Conventionally, the data on a liquid crystal display has been corrected a number of times. Among the corrections, the correction of color brightness is often referred to as a gamma correction. FIG. 5 is a block diagram showing the major components of a conventional liquid crystal display. The color correction circuit 500 of the display in FIG. 5 comprises a data driving circuit 520 and an N-bit gamma correction circuit 530.

A video source transmits N bit video data of the color red, N bit video data of the color green and N bit video data of the color blue to the data driving circuit 520. The data driving circuit 520 picks up the N bit video data of the color red, green and blue and then re-transmits these data to the N-bit gamma correction circuit 530 for correction. The N-bit gamma correction circuit 530 corrects the N-bit video data of the three colors according to a predetermined color data range in a lookup table under a gamma correction curve. Thereafter, the corrected data is transmitted back to the data driving circuit 520. Finally, the data driving circuit 520 drives the liquid crystal display panel 540 using a driving voltage based on the corrected N bit video data.

Because the conventional correction technique uses the same gamma correction curve for correcting the video data in all three colors, namely red, green and blue, the color data range is fixed. Hence, all three colors have the same driving voltage but a different transmittance. Consequently, the color temperature of white color may differ significantly in a different gray scale. Moreover, the difference is non-adjustable.

### SUMMARY OF INVENTION

Accordingly, the present invention is directed to a color correction circuit of a display capable of modulating N bit video data into N+1 bit video data or greater than N+1 bit video data and providing the voltages in every step according to a gamma color correction table so that each of the three colors including red, green and blue can have an independent gamma correction curve to improve performance of each color.

The present invention is also directed to a method of correcting the colors in a display through modulating N bit video data into a N+M bit video data and providing the voltages in every step of the N+M bit video data so that the brightness and darkness level of each color is optimized to improve contrast. For better implement consideration, M may be chosen from natural numbers.

According to an embodiment of the present invention, the color correction circuit is coupled to a video source and a display panel. The color correction circuit comprises a video look-up circuit, N+M bit data driving circuit and N+M bit data gamma voltage generating circuit. The video look-up circuit inside the color correction circuit modulates N bit video data from the video source into N+M bit video data according to a color look-up table. The modulated video data is transmitted to the N+M bit data gamma voltage generating circuit through the N+M bit data driving circuit. The N+M bit data gamma voltage generating circuit provides the voltages in every step based on the values in the gamma color correction table that corresponds to the N+M bit video data.

According to one embodiment of the present invention, the N+M bit data gamma generating circuit is a gamma correction circuit.

According to one embodiment of the present invention, the N+M bit video data comprises N+M bit video data for the color red.

According to one embodiment of the present invention, the N+M bit video data comprises N+M bit video data for the color green.

According to one embodiment of the present invention, the N+M bit video data comprises N+M bit video data for the color blue.

According to one embodiment of the present invention, the liquid crystal display panel displays the corrected N+M bit video data.

The present invention is also directed to a method of correcting the colors of a display. The method includes the following steps. After receiving N bit video data, the N bit video data is modulated into N+M bit video data according to a color look-up table. Thereafter, the voltage in every step is provided based on the values in a gamma color correction table that corresponds to the N+M bit video data. Finally, the voltages are used to drive the display panel.

In the present embodiment of the present invention, N bit video data from a video source is modulated into N+M bit video data. Therefore, through the voltages in every step produced by the N+M bit data gamma voltage generating circuit based on the gamma color correction table, each of the three colors including red, green and blue can have an independent gamma correction curve for improving color contrast.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram showing the components of a liquid crystal display according to one embodiment of the present invention.

FIG. 2 is a flow diagram showing the steps for correcting the colors in a display according to one embodiment of the present invention.

FIG. 3 is a graph showing the transmittance versus driving voltage curves of a color correction circuit according to one embodiment of the present invention.

FIG. 4 is a graph showing the color look-up curves of a color correction circuit according to one embodiment of the present invention.

FIG. 5 is a block diagram showing the major components of a conventional liquid crystal display.

### DETAILED DESCRIPTION

Reference will now be made in detail to the present preferred embodiments of the invention, examples of which are illustrated in the accompanying drawings. Wherever possible, the same reference numbers are used in the drawings and the description to refer to the same or like parts.

FIG. 1 is a block diagram showing the components of a liquid crystal display according to one embodiment of the present invention. In the present embodiment, the color correction circuit 100 of the display modulates N bit video data into N+M bit video data and then provides the voltages in every step. Thus, each of the colors including red, green and blue can have its own gamma correction curve. In some cases, M could be chosen as 1 to simplify the total calculation or table inspection. However, those with ordinary arts should know that the amount of added bits for any one of the video data could be N+M bits, wherein the number M is any natural number. The color correction circuit 100 in FIG. 1 comprises a video look-up circuit 110, N+M bit data driving circuit 120 and N+M bit data gamma voltage generating circuit 130. The video look-up circuit 110 is coupled to a video source and the N+M bit data driving circuit 120. The N+M bit data driving circuit 120 is coupled to the N+M bit data gamma voltage generating circuit 130 and a display panel 140.

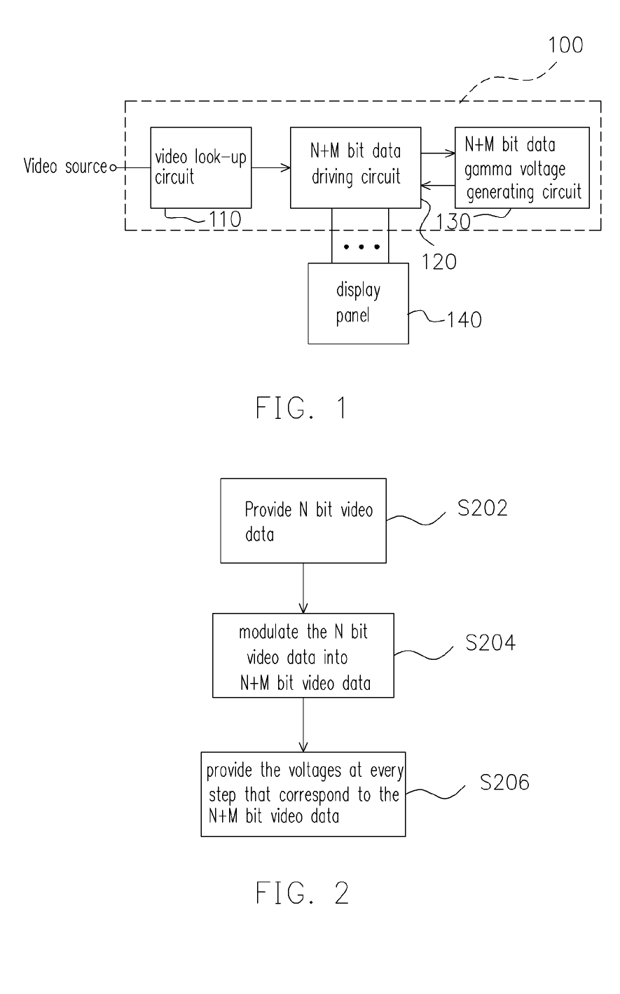

FIG. 2 is a flow diagram showing the steps for correcting the colors in a display according to one embodiment of the present invention. As shown in FIGS. 1 and 2, the video look-up circuit 110 picks up N bit video data of the color red, green and blue from the video source (in step s202). According to a built-in color look-up table, the N bit video data of the colors are modulated into N+M bit video data and then output to the N+M bit data driving circuit 120 (in step s204). On receiving the modulated N+M bit video data, the N+M bit data driving circuit 120 transmit the video data to the N+M bit data gamma voltage generating circuit 130. Thereafter, the N+M bit data gamma voltage generating circuit 130 provides the voltages at every step according to the values in a gamma color correction table that correspond to the N+M bit video data (in step s206). The N+M bit data gamma voltage generating circuit 130 can be a gamma correction circuit. However, the scope of the present invention is not limited as such.

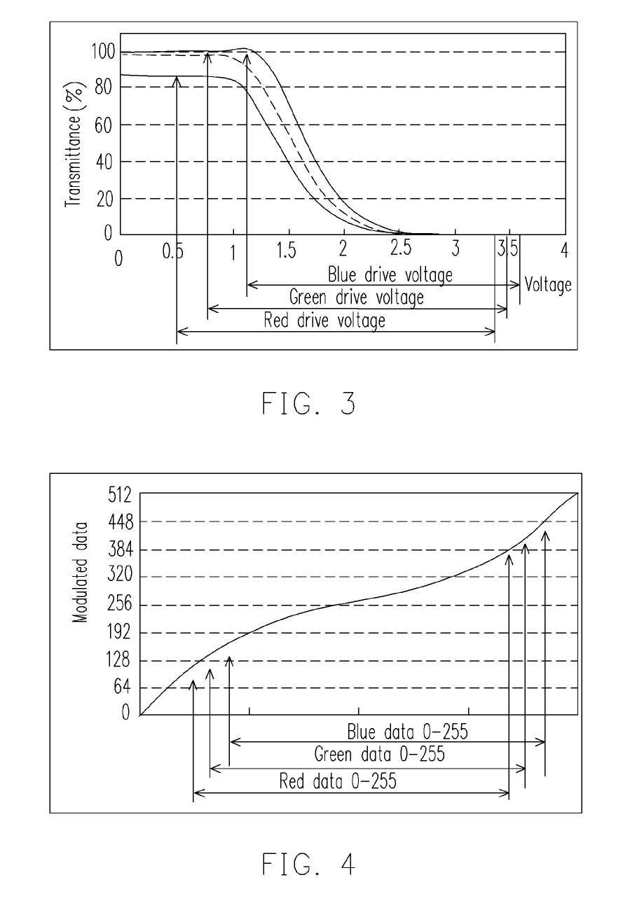

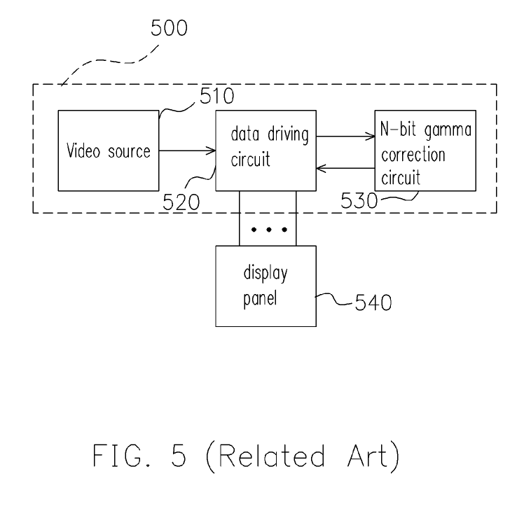

FIG. 3 is a graph showing the transmittance versus driving voltage curves of a color correction circuit according to one embodiment of the present invention. FIG. 4 is a graph showing the color look-up curves of a color correction circuit according to one embodiment of the present invention. To simplify explanation, the modulated video data in FIG. 4 has 9 bits. However, this should by no means limits the number of bits in the present invention as such.

After receiving the N+M bit video data, the N+M bit data gamma voltage generating circuit 130 produces the voltages of every step based on the data range of red, green, blue as indicated in the gamma correction curves of FIG. 4. Each color has its own video data range instead of all having the same data range. In other words, red has an independent gamma correction curve, green has an independent gamma correction curve and blue has an independent gamma correction curve after the correction. Thereafter, the N+M bit data gamma voltage generating circuit 130 outputs the corrected video data to the N+M bit data driving circuit 120.

Finally, according to the corrected N+M bit video data, the N+M bit data driving circuit 120 produces the voltage demanded by each color (as shown in FIG. 3, the voltage of each color at the same transmittance so that each color can have an optimal brightness level) to drive the liquid crystal panel 140 and display the corrected at least N+M bit video data.

In the embodiment of the present invention, the N+M bit video data comprises N+M bit video data for the colors red, green or blue, respectively.

In the embodiment of the present invention, the gamma correction curve of the colors red, green, blue can be independently adjusted. Furthermore, through the adjustment of the gamma color correction table, the composition of the three colors can be varied so that the white color in different gray scale can have the same color temperature. In other words, color deviation in different gray scales is greatly reduced.

In the embodiment of the present invention, the red, green and blue video data each has its own driving voltage.

In summary, the advantages of the color correction circuit and correction method of the present invention includes:

1. The three colors, namely red, green and blue, can be independently adjusted through their respective gamma correction curves.

2. Through the adjustment of the gamma color correction table, the composition of the three colors, namely red, green and blue, can be varied so that white color in different gray scales can have the same color temperature.

3. Each of the three colors, namely red, green and blue, operates in their own best voltage range so that the brightness and darkness level of each color is optimized to improve contrast.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A color correcting circuit coupled to a video source and a display panel, comprising:
a video look-up circuit, coupled to the video source, wherein an N bit video data from the video source is modulated into a N+M bit video data according to a color look-up table;
a N+M bit data driving circuit, coupled to the video lookup circuit for receiving and outputting the N+M bit video data; and
a N+M bit data gamma voltage generating circuit, coupled to the N+M bit data driving circuit for receiving the N+M bit video data and providing the voltages in every step according to the values found in a gamma color correction table, wherein, M is a natural number.

2. The color correction circuit of claim 1, wherein the N+M bit data gamma voltage generating circuit comprises a gamma correction circuit.

3. The color correction circuit of claim 1, wherein the N+M bit video data comprises N+M bit video data for the color red.

4. The color correction circuit of claim 1, wherein the N+M bit video data comprises N+M bit video data for the color green.

5. The color correction circuit of claim 1, wherein the N+M bit video data comprises N+M bit video data for the color blue.

6. The color correction circuit of claim 1, wherein the display panel displays the corrected N+M bit video data.

7. A method of correcting the colors of a display, comprising the steps of:
providing an N bit video data;
modulating the N bit video data into aN+M bit video data according to a color look-up table; and providing the voltages of every step for the N+M bit video data according to the values found from a gamma color correction table,
wherein, M is a natural number.

8. The method of claim 7, wherein the N+M bit video data comprises N+M bit video data for the color red.

9. The method of claim 7, wherein the N+M bit video data comprises N+M bit video data for the color green.

10. The method of claim 7, wherein the N+M bit video data comprises N+M bit video data for the color blue.
